(19) United States
(12) Patent Application Publication
(10) Pub. No.: US 2026/0088462 A1
(43) Pub. Date: Mar. 26, 2026

(54) SECONDARY BATTERY ELECTRODE AND ELECTRODE ASSEMBLLY INCLUDING SECONDARY BATTERY ELECTRODE

(71) Applicant: SAMSUNG SDI CO., LTD., Yongin-Si Gyeonggi-do (KR)

(72) Inventor: Juhyung Lee, Yongin-Si Gyeonggi-do (KR)

(21) Appl. No.: 19/086,344

(22) Filed: Mar. 21, 2025

(30) Foreign Application Priority Data
Sep. 24, 2024 (KR) 10-2024-0128874

(51) Int. Cl. H01M 50/534; H01M 10/04

(52) U.S. Cl. CPC H01M 50/534; H01M 10/0431

(57) ABSTRACT

A secondary battery electrode includes a substrate including a first surface and a second surface opposite to the first surface, mixture portions formed on the first surface, an uncoated portion formed between the mixture portions on the first surface, an electrode tab joined to the uncoated portion and protruding from the uncoated portion, and a tape in contact with the first surface of and including two side end portions and a central portion formed between the two side end portions. An adhesive layer is formed on the two side end portions, and the tape covers a part of the electrode tab and at least a part of the uncoated portion.

### CROSS-REFERENCE TO RELATED APPLICATION

This present application claims priority to and the benefit under 35 U.S.C. § 119 (a)-(d) of Korean Application No. 10-2024-0128874, filed in the Korean Intellectual Property Office on Sep. 24, 2024, the entire disclosure of which is incorporated herein by reference.

### BACKGROUND

### 1. Field

The present disclosure relates to a secondary battery electrode and an electrode assembly including the secondary battery electrode. More specifically, the present disclosure relates to a secondary battery including a tape attached to an uncoated portion and an electrode assembly including the tape attached to the uncoated portion.

### 2. Description of Related Art

While primary batteries are not designed to be (re) charged, secondary (also known as rechargeable) batteries are designed to be discharged and recharged. Among secondary batteries, low-capacity secondary batteries are widely used in portable, small electronic devices, such as smart phones, feature phones, notebook computers, digital cameras, and camcorders, while high-capacity secondary batteries are widely used as power sources for driving motors in hybrid vehicles and electric vehicles, as well as for storing power (e.g., home and/or utility scale power storage). A secondary battery generally includes an electrode assembly including a positive electrode and a negative electrode, a case accommodating both electrodes, and electrode terminals connected to the electrode assembly.

Secondary batteries typically include an electrode assembly, in which a positive electrode plate, a negative electrode plate, and a separator are sequentially stacked, and also include a battery can that houses the electrode assembly along with an electrolyte or a solid electrolyte.

Here, the electrode assembly may be configured in various forms depending on the structure of the secondary battery. For instance, the electrode assembly may be a jelly roll-type assembly where long sheet-shaped positive and negative electrode plates are wound together with a separator interposed between the positive and negative electrode plates. Alternatively, the electrode assembly may be a stacked assembly in which multiple positive and negative electrode plates are sequentially stacked with separators interposed between these plates.

The positive and negative electrode plates that form the electrode assembly are typically connected to electrode tabs, which serve as terminals for electrical connection. These electrode plates may have uncoated portions where no active material is applied. The electrode tabs may be welded to these uncoated portions. During the charging and discharging cycles of the secondary battery, swelling may occur, i.e., the electrodes may tend to expand. When forming the electrode assembly, the battery is activated by repeat charging and discharging, and, during the activation, the active material may expand, leading to swelling. The expansion rate can vary depending on the type of active material.

Regardless of whether the electrode assembly is configured as either a winding (jelly roll) type assembly or a stacked-type assembly, pressure and stress may accumulate at the electrode tab attachment areas of the electrode plate, due to various step heights, tab thicknesses, and rigidities, leading to the formation of cracks. Although a substrate having a low-expansion active material may be sufficient to prevent such issues, high-capacity secondary batteries typically use a relatively high-expansion active material therefore, using a substrate alone may not be enough to prevent stress concentration in relevant areas, resulting in crack formation. Cracks that occur around electrode tabs may be detrimental because reliability (e.g., capacity and lifespan) may be reduced, short circuits or electrical faults may happen, or in worst cases, the secondary battery cell may ignite.

The information disclosed in this Background section is for enhancement of understanding of the background of the present disclosure. The section may contain information that does not constitute related (or prior) art.

### SUMMARY

Embodiments of the present disclosure provide a cap assembly and a secondary battery.

Embodiments of the present disclosure provide a secondary battery electrode including a substrate portion including a first surface and a second surface opposite to the first surface, a plurality of mixture portions formed on the first surface, an uncoated portion formed between the mixture portions on the first surface, an electrode tab joined to the uncoated portion of the first surface and protruding from the uncoated portion of the first surface, and a first tape in contact with the first surface of the substrate portion and including two end portions and a central portion formed between the two end portions, wherein adhesive layers are formed only on the two end portions, and the first tape is configured to cover a part of the electrode tab and the uncoated portion of the first surface.

Embodiments of the present disclosure provide a secondary battery electrode, including: a substrate including a first surface and a second surface opposite to the first surface; a plurality of mixture portions formed on the first surface; an uncoated portion formed between the plurality of mixture portions on the first surface; an electrode tab joined to the uncoated portion and externally protruding from the uncoated portion; and a tape in contact with the first surface and comprising two side end portions and a central portion formed between the two side end portions, wherein an adhesive layer is formed on the two side end portions, and wherein the tape covers a part of the electrode tab and at least a part of the uncoated portion.

According to an embodiment, the adhesive layer may be parallel to a protruding direction of the electrode tab, may be positioned at left and right end portions of the first tape, and may be bonded to the mixture portion.

In an embodiment, the adhesive layer exists parallel to an externally protruding direction of the electrode tab and wherein the adhesive layer is adhered to the plurality of mixture portions.

According to an embodiment, the secondary battery electrode may further include a second tape configured to be in contact with the second surface of the substrate portion at a position corresponding to the first tape and cover an uncoated portion of the second surface and a mixture portion of the second surface, and having an adhesive layer over an entire area.

In an embodiment, the secondary battery electrode further includes: a second uncoated portion formed between the second plurality of mixture portions on the second surface; a second tape in contact with the second surface at a position corresponding to the tape, wherein a second adhesive layer is formed on an entire area of the second tape, and wherein the second tape covers at least a part of the second uncoated portion and at least a part of the second plurality of mixture portions,

According to an embodiment, the adhesive layer may be positioned in a direction perpendicular to a protruding direction of the electrode tab and may be positioned at an upper end and a lower end of the first tape so as not to overlap with the mixture portion.

In an embodiment, the adhesive layer exists perpendicular to an externally protruding direction of the electrode tab, wherein the adhesive layer is positioned at an upper end and a lower end of the tape, and wherein the adhesive layer does not overlap with the plurality of mixture portions,

According to an embodiment, the secondary battery electrode may further include a second tape configured to be in contact with the second surface of the substrate portion at a position corresponding to the first tape and bonded to the first tape, wherein the second tape may have an adhesive layer over an entire area and may be configured to cover an uncoated portion of the second surface, the mixture portion of the second surface, and a part of the electrode tab.

In an embodiment, the secondary battery electrode further includes: a second uncoated portion formed between the second plurality of mixture portions on the second surface; a second tape in contact with the second surface at a position corresponding to the tape, wherein a second adhesive layer is formed on an entire area of the second tape, and wherein the second tape covers at least a part of the second uncoated portion, at least a part of the second plurality of mixture portions, and at least a part of the electrode tab.

According to an embodiment, the adhesive layer may be positioned in a direction perpendicular to a protruding direction of the electrode tab and may be positioned at an upper end and a lower end of the first tape so as to overlap with the mixture portion.

In an embodiment, the adhesive layer exists perpendicular to an externally protruding direction of the electrode tab, wherein the adhesive layer is positioned at an upper end and a lower end of the tape, and wherein at least a part of the adhesive layer overlaps with at least a part of the plurality of mixture portions.

According to an embodiment, the secondary battery electrode may further include a second tape configured to be in contact with the second surface of the substrate portion at a position corresponding to the first tape and cover an uncoated portion of the second surface and a mixture portion of the second surface, and having an adhesive layer over an entire area.

In an embodiment, the secondary battery electrode further includes: a second uncoated portion formed between the second plurality of mixture portions on the second surface; a second tape in contact with the second surface at a position corresponding to the tape, wherein a second adhesive layer is formed on an entire area of the second tape, and wherein the second tape covers at least a part of the second uncoated portion and at least a part of the second plurality of mixture portions.

According to an embodiment, a width of the adhesive layer may be 2.5 mm to 5.0 mm.

In an embodiment, the adhesive layer has a width of about 2.5 mm to about 5.0 mm.

According to an embodiment, a thickness of the adhesive layer may be 5 μm to 15 μm.

In an embodiment, the adhesive layer has a thickness of about 5 μm to about 15 μm.

According to an embodiment, a material of the adhesive layer may include an acrylic co-polymer or a rubber sealant.

In an embodiment, the adhesive layer includes an acrylic co-polymer or a rubber sealant.

According to an embodiment, the material of the first tape may include one of polypropylene (PP), polyethylene (PE), polyethylene terephthalate (PET), polystyrene (PS), and polyimide (PI), or any combination thereof.

In an embodiment, the tape includes polypropylene, polyethylene, polyethylene terephthalate, polystyrene, polyimide, or any combination thereof.

According to an embodiment a thickness of the first tape may be 10 μm to 50 μm.

In an embodiment, the tape has a thickness of about 10 μm to about 50 μm.

Embodiments of the present disclosure provide an electrode assembly including a first electrode, a second electrode, and a separator positioned between the first electrode and the second electrode, wherein at least one of the first electrode or the second electrode includes a substrate portion including a first surface and a second surface opposite to the first surface, a plurality of mixture portions formed on the first surface, an uncoated portion formed between the mixture portions on the first surface, an electrode tab joined to the uncoated portion of the first surface and protruding from the uncoated portion of the first surface, and a first tape in contact with the first surface of the substrate portion and including two end portions and a central portion formed between the two end portions, wherein adhesive layers are formed only on the two end portions, wherein the first tape is configured to cover a part of the electrode tab and the uncoated portion of the first surface.

Embodiments of the present disclosure provide an electrode assembly including: a first electrode, a second electrode, and a separator positioned between the first electrode and the second electrode, wherein the first electrode and/or the second electrode includes: a substrate including a first surface and a second surface opposite to the first surface; a plurality of mixture portions formed on the first surface; an uncoated portion formed between the plurality of mixture portions on the first surface; an electrode tab joined to the uncoated portion and externally protruding from the uncoated portion; and a tape in contact with the first surface and comprising two side end portions and a central portion formed between the two side end portions, wherein an adhesive layer is formed on the two side end portions, and wherein the tape covers a part of the electrode tab and at least a part of the uncoated portion.

According to an embodiment, the adhesive layer may be parallel to a protruding direction of the electrode tab, may be positioned at left and right end portions of the first tape, and may be bonded to the mixture portion.

In an embodiment, the adhesive layer exists parallel to an externally protruding direction of the electrode tab and wherein the adhesive layer is adhered to the plurality of mixture portions.

According to an embodiment, the electrode assembly may further include a second tape configured to be in contact with the second surface of the substrate portion at a position corresponding to the first tape and cover an uncoated portion of the second surface and a mixture portion of the second surface, and having an adhesive layer over an entire area.

In an embodiment, the first electrode and/or the second electrode further includes: a second uncoated portion formed between the second plurality of mixture portions on the second surface; a second tape in contact with the second surface at a position corresponding to the tape, wherein a second adhesive layer is formed on an entire area of the second tape, and wherein the second tape covers at least a part of the second uncoated portion and at least a part of the second plurality of mixture portions,

According to an embodiment, the adhesive layer may be positioned in a direction perpendicular to a protruding direction of the electrode tab and may be positioned at an upper end and a lower end of the first tape so as not to overlap with the mixture portion.

In an embodiment, the adhesive layer exists perpendicular to an externally protruding direction of the electrode tab, wherein the adhesive layer is positioned at an upper end and a lower end of the tape, and wherein the adhesive layer does not overlap with the plurality of mixture portions.

According to an embodiment, the electrode assembly may further include a second tape configured to be in contact with the second surface of the substrate portion at a position corresponding to the first tape and bonded to the first tape, wherein the second tape may have an adhesive layer over an entire area and may be configured to cover an uncoated portion of the second surface, the mixture portion of the second surface, and a part of the electrode tab.

In an embodiment, the first electrode and/or the second electrode further includes: a second uncoated portion formed between the second plurality of mixture portions on the second surface; a second tape in contact with the second surface at a position corresponding to the tape, wherein a second adhesive layer is formed on an entire area of the second tape, and wherein the second tape covers at least a part of the second uncoated portion, at least a part of the second plurality of mixture portions, and a part of the electrode tab,

According to an embodiment, the adhesive layer may be positioned in a direction perpendicular to a protruding direction of the electrode tab and may be positioned at an upper end and a lower end of the first tape so as to overlap with the mixture portion.

In an embodiment, the adhesive layer exists perpendicular to an externally protruding direction of the electrode tab, wherein the adhesive layer is positioned at an upper end and a lower end of the tape, and wherein at least a part of the adhesive layer overlaps with at least a part of the plurality of mixture portions.

According to an embodiment, the electrode assembly may further include a second tape configured to be in contact with the second surface of the substrate portion at a position corresponding to the first tape and cover an uncoated portion of the second surface and a mixture portion of the second surface, and having an adhesive layer over an entire area.

In an embodiment, a second uncoated portion formed between the second plurality of mixture portions on the second surface; a second tape in contact with the second surface at a position corresponding to the tape, wherein a second adhesive layer is formed on an entire area of the second tape, and wherein the second tape covers at least a part of the second uncoated portion and at least a part of the second plurality of mixture portions,

According to an embodiment, the electrode assembly may be formed by winding the first electrode, the separator, and the second electrode in a form of a jelly roll, or may be formed by stacking the first electrode, the separator, and the second electrode in a form of a stack.

Embodiments of the present disclosure provide a method for producing the electrode assembly including: winding the first electrode, the separator, and the second electrode to form a jelly roll type electrode assembly, or stacking the first electrode, the separator, and the second electrode to form a stacked type electrode assembly.

According to various embodiments of the present disclosure, cracks that may occur in the secondary battery electrode plate may be prevented.

According to various embodiments of the present disclosure, the spread of cracks occurring in the substrate connected to the electrode tab may be prevented by forming the non-adhesive layer of the tape.

According to various embodiments of the present disclosure, cracks may be prevented from occurring in the electrode plate by selectively attaching the manufactured tape.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 shows an electrode assembly according to embodiments of the present disclosure;

FIG. 2 shows a secondary battery electrode according to embodiments of the present disclosure;

FIGS. 3A and 3B show a secondary battery electrode, to which a tape is attached, according to embodiments of the present disclosure;

FIGS. 4A-4C show a secondary battery electrode, to which a tape is attached, according to embodiments of the present disclosure;

FIG. 5 shows a secondary battery electrode, to which a tape is attached, according to embodiments of the present disclosure;

FIGS. 6A-6B show a tape according to embodiments of the present disclosure;

FIG. 7 shows a first tape according to embodiments of the present disclosure; and

FIG. 8 is a flowchart showing a process related to a first tape according to embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

The embodiments described herein can be explained with reference to cross-sectional views and/or plain views as example views of the present disclosure. In the drawing, the thicknesses of films and regions can be exaggerated for effective description of technical contents. Thus, regions presented as an example in the drawings have general properties, and shapes of the exemplified areas can be used to illustrate a specific shape of a device region. Therefore, this should not be construed as limited to the scope of the present disclosure. Although the terms such as first, second, and third are used to describe various components in various embodiments herein, the components should not be limited to these terms. These terms are used only to distinguish one component from another component. Embodiments described and exemplified herein include complementary embodiments thereof. Like reference numerals refer to like elements throughout the specification.

As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

As used herein, an “electrode assembly” may be formed or manufactured by winding or stacking a stack of a positive electrode plate, a separator, and a negative electrode plate formed in a thin plate shape or a film shape. The positive electrode plate may be formed by applying a positive electrode active material, made of, for example, a transition metal oxide, onto a positive electrode current collector plate including a metal foil or a metal layer made of, for example, aluminum. The negative electrode plate may be formed by applying a negative electrode active material made of, for example, graphite or carbon, onto a negative electrode current collector plate including a metal foil or a metal layer made of, for example, copper or nickel. The metal foil or the metal layer may include a metal foil or a metal layer positioned on a polymer substrate.

As used herein, the term “separator” may refer to an intermediate layer that continuously maintains ionic conductivity while isolating the positive electrode and the negative electrode from each other in the battery, thereby enabling charging and discharging of the battery. The separator may include a multilayer of two or more layers made of polyethylene, polypropylene, polyvinylidene, fluoride, or the like.

As used herein, the term “formation process” refers to a process of activating a battery by repeat charging and discharging after assembling the battery. The active material inside the battery may expand during the formation process, causing swelling.

As used herein, the term “internal expansion ratio” refers to a ratio between thicknesses of the electrode of the secondary battery before and after formation. In an embodiment, the term “internal expansion ratio” may refer to a ratio between thicknesses of the secondary battery electrode after formation and before formation.

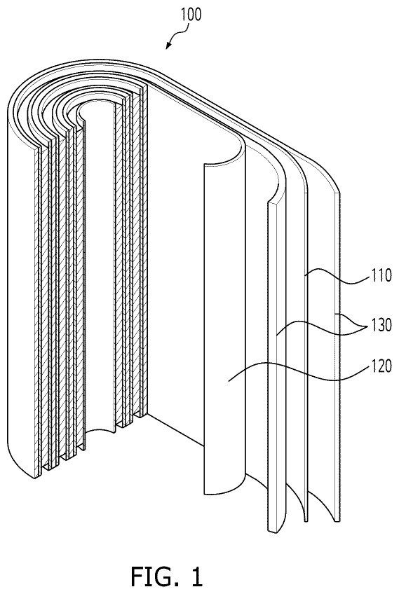

FIG. 1 shows an electrode assembly 100 according to embodiments of the present disclosure.

The electrode assembly 100 may include a first electrode 110, a second electrode 120, and a separator 130.

In an embodiment, the electrode assembly 100 may have a wound structure, for example, in the form of a jelly roll, with an insulating separator 130 provided between the first electrode 110 and the second electrode 120. In an embodiment, the electrode assembly 100 may have a stacked structure in which the insulating separator 130 is provided between the first electrode 110 and the second electrode 120.

In some embodiments, the first electrode 110 may include a positive electrode plate. The first electrode 110 may include a substrate portion, a mixture portion (that is, a region where an active material is applied), and an uncoated portion (that is, an uncoated region where an active material is not applied). In some embodiments, the first electrode 110 may include a first electrode tab on the uncoated portion. When the electrode assembly 100 has a wound structure in the form of a jelly roll, the wound structure may be formed such that the surface of the first electrode 110 with the positive electrode tab on the uncoated portion corresponds to the inner surface, and the surface opposite to the surface with the positive electrode tab corresponds to the outer surface.

In some embodiments, the second electrode 120 may include a negative electrode plate. The second electrode 120 may include a substrate portion, a mixture portion (that is, a region where an active material is applied), and an uncoated portion (that is, an uncoated region where an active material is not applied). In some embodiments, the second electrode 120 may include a second electrode tab on the uncoated portion. When the electrode assembly 100 has a wound structure in the form of a jelly roll, the wound structure may be formed such that the surface of the second electrode 120 with the second electrode tab on the uncoated portion corresponds to the inner surface, and the surface opposite to the surface with the second electrode tab corresponds to the outer surface.

In some embodiments, the electrode assembly 100 has a wound structure in the form of a jelly roll, and the surface where the first electrode is not joined to the first electrode tab and/or the surface where the second electrode is not joined to the second electrode tab may correspond to the outer surface.

In some embodiments, the electrode assembly has a wound structure in the form of a jelly roll, and the wound structure may be formed such that the surface of the first electrode 110 and/or the second electrode 120 with the first electrode tab and/or the second electrode tab on the uncoated portion corresponds to the outer surface, and the surface opposite to the surface with the first electrode tab and/or the second electrode tab corresponds to the inner surface.

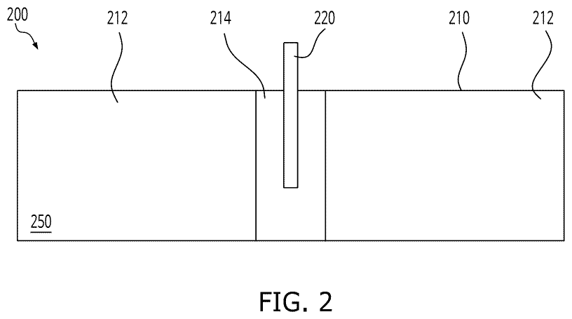

FIG. 2 shows a secondary battery electrode 200 according to embodiments of the present disclosure.

The secondary battery electrode 200 may include a substrate portion 210, a mixture portion 212, an uncoated portion 214, and an electrode tab 220.

The substrate portion 210 is configured to fix the frame of the secondary battery electrode 200. The substrate portion 210 may include a first surface 250 and a second surface (not shown). The second surface of the substrate portion 210 may be located on the opposite side of the first surface 250. The substrate portion 210 may include copper (Cu) or aluminum (Al), but the present disclosure is not limited thereto. In an embodiment, the substrate portion 210 may be manufactured utilizing various methods known in the art.

The mixture portion 212 may be formed on one surface or both surfaces of the substrate portion 210. In an embodiment, the mixture portion 212 may be formed on the first surface 250 or the second surface of the substrate portion 210. In some embodiments, the mixture portion 212 may be formed on both the first surface 250 and the second surface opposite to the first surface of the substrate portion 210. The mixture portion 212 may include a region where an active material is applied onto the substrate portion 210. The uncoated portion 214 may be formed between multiple mixture portions 212. The uncoated portion 214 may be formed on the first surface 250 of the substrate portion 210 and the second surface opposite to the first surface 250 of the substrate portion 210. The uncoated portion 214 may refer to an uncoated region where an active material is not formed on the substrate portion 210.

The electrode tab 220 may be joined to the uncoated portion 214 on the first surface 250 of the substrate portion 210. In some embodiments, only a part of the electrode tab 220 may be joined to the first surface 250 of the uncoated portion 214, so that the remaining part of the electrode tab 220 may not be joined to the base portion 210 and may protrude in an external direction relative to the substrate portion 210. This way, the electrode tab 220 may transmit electricity to the exterior environment. The joining the electrode tab 220 and the substrate portion 210 may be done utilizing a welding method, but the present disclosure is not limited thereto.

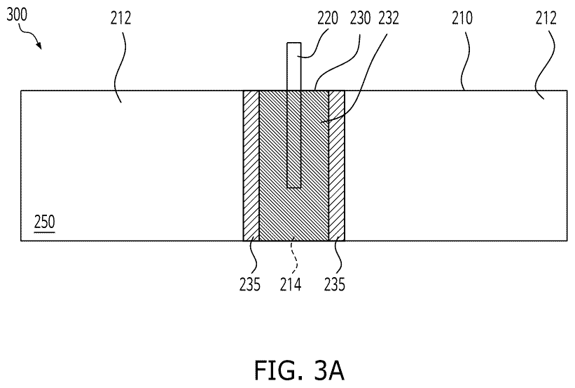

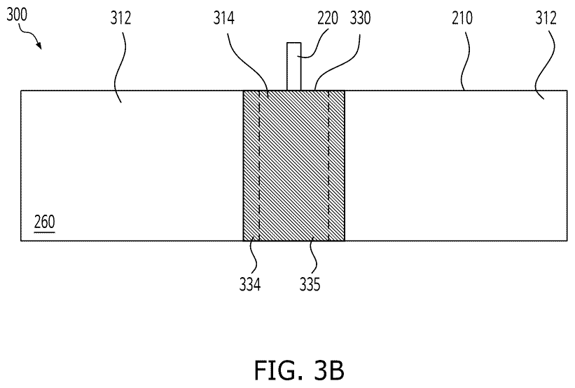

FIGS. 3A and 3B show a secondary battery electrode 300, to which a tape is attached, according to embodiments of the present disclosure. FIG. 3A shows a first surface 250 of a substrate portion 210 of the secondary battery electrode 300. FIG. 3B shows a second surface 260 opposite to the first surface 250 of the substrate portion 210 of the secondary battery electrode 300.

FIG. 3A shows a first tape 230 being in contact with the first surface 250 of the substrate portion 210. The first tape 230 may be in contact with the first surface 250. The first tape 230 may cover a part of the electrode tab 220 joined to the uncoated portion 214 formed between mixture portions 212 on the first surface 250. The first tape 230 may cover the joining region between the uncoated portion 214 and the electrode tab 220.

The first tape 230 may include a central portion 232 and two side end portions (not shown). Adhesive layers 235 may be respectively formed at the two side end portions. The central portion 232 includes a portion made only of a fabric of the tape and may be a portion where no adhesive is applied. The central portion 232 may include a non-adhesive portion. The central portion 232 may be in contact with the uncoated portion 214 on the first surface 250 of the substrate portion 210. The area of the central portion 232 may be equal to the area of the uncoated portion 214 on the first surface 250. The area of the central portion 232 may also include the joining area between the uncoated portion 214 and the electrode tab 220. The central portion 232 may cover a part of the electrode tab 220 joined to the uncoated portion 214 on the first surface 250.

The adhesive layer 235 may include a portion where an adhesive is applied. The adhesive layer 235 may be formed only at the two side end portions of the first tape 230. The adhesive layer 235 may be formed parallel to the externally protruding direction of the electrode tab 220. The adhesive layer 235 may be formed only at both side end portions (e.g., left hand side and right hand side end portions of FIG. 3A) of the first tape 230. The adhesive layer 235 may be bonded to the mixture portion 212 on the first surface 250 of the substrate portion 210. The adhesive layer 235 may be bonded only to the mixture portion 212 and may not be in contact with the uncoated portion 214 on the first surface 250 of the substrate portion 210. In some embodiments, the adhesive layer 235 may be in contact with the mixture portion 212 and the uncoated portion 214.

FIG. 3B shows a second tape 330 in contact with the second surface 260 opposite to the first surface 250 of the substrate portion 210. The second tape 330 may be bonded to a position corresponding to the first tape 230. The second tape 330 may include an adhesive layer 335. The entire area of the second tape 330 may include the adhesive layer 335. The second tape 330 may be bonded to a part 334 (corresponding to the two side end portions) of the uncoated portion 314 and the mixture portion 312 on the second surface 260. In an embodiment, the second tape may not be bonded to the second surface 260 of the substrate portion 210. Due to the existence of the electrode tab 220, the adhesive layer may contribute to forming cracks on or in the substrate portion 210. Further formation of cracks may be prevented by removing a portion of the adhesive layer 335 that may be in contact with the electrode tab 220. In some embodiments, further formation of cracks may be prevented by removing all of the adhesive layer 335 from the uncoated portion 214 on the first surface 250 where the electrode tab 220 is joined.

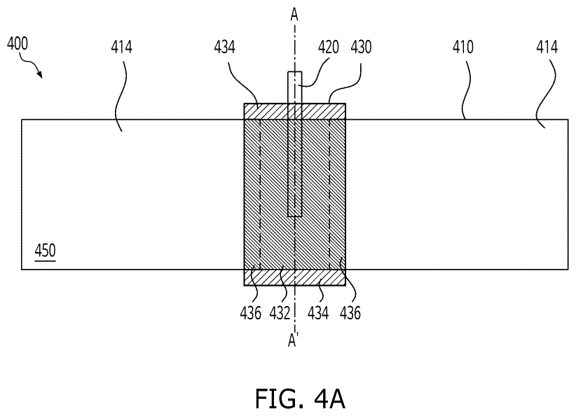

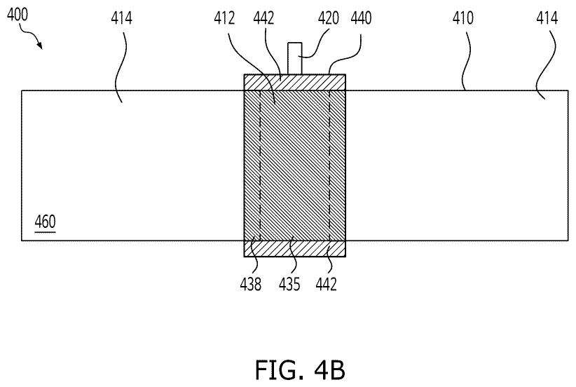

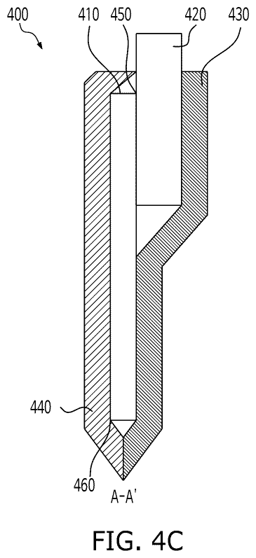

FIGS. 4A-4C show a secondary battery electrode 400, to which a tape is attached, according to embodiments of the present disclosure. FIG. 4A shows a first surface 450 of a substrate portion 410 of the secondary battery electrode 400. FIG. 4B shows a second surface 460 opposite to the first surface 450 of the substrate portion 410 of the secondary battery electrode 400. FIG. 4C shows a cross-section taken along A-A′ of FIG. 4A.

FIG. 4A shows a first tape 430 in contact with the first surface 450 of the substrate portion 410. The uncoated portion (not shown) may be formed between the mixture portions 414. The first tape 430 may cover a part of the electrode tab 420 joined to the uncoated portion on the first surface 450.

The first tape 430 may include a central portion 432 and two side end portions (not shown). One or more adhesive layers, forming a protruding adhesive layer 434, may be respectively formed at the two end portions. The central portion 432 includes a portion made only of a fabric of the tape or may be a portion where no adhesive is applied. The central portion 432 may include a non-adhesive portion. The central portion 432 may be in contact with the uncoated portion on the first surface 450 of the substrate portion 410. The central portion 432 may overlap with a part 436 of the mixture portion 414 of the first surface 450. The central portion 432 may cover a part of the electrode tab 420 joined to the uncoated portion of the first surface 450. The central portion 432 may cover the entire joining portion between the uncoated portion and the electrode tab 420. The central portion 432 may overlap with a part of the mixture portion 414.

The adhesive layer 434 may include a portion where an adhesive is applied. The adhesive layer 434 may be formed in a direction perpendicular to the externally protruding direction of the electrode tab 420. The adhesive layer 434 may be formed only on two side end portions of the first tape 430. The adhesive layer 434 may be formed at the upper end and the lower end (both the upper end and lower end perpendicular from the two side end portions) of the first tape 430. The adhesive layer 434 may be formed external to the substrate portion 410. The adhesive layer 434 may not overlap with the mixture portion 414. The adhesive layer 434 may be formed to protrude in the external direction from the upper end and the lower end of the substrate portion 410. The adhesive layer 434 formed on the upper end of the first tape 430 may overlap with a part of the electrode tab 420 protruding in the external direction. The adhesive layer 434 may not be in contact with the uncoated portion and the mixture portion 414.

FIG. 4B shows a second tape 440 in contact with the second surface 460 opposite to the first surface 450 of the substrate portion 410. The second tape 440 may be bonded to a position corresponding to the first tape 430 on the second surface 460. The second tape 440 may include an adhesive layer 435. The entire area of the second tape 440 may include the adhesive layer 435. The second tape 440 may overlap with a part of the mixture portion 414. The second tape 440 may protrude in the external direction from the upper end and the lower end of the substrate portion 410 forming a protruding adhesive portion 442 so as to be fixed to the first tape 430. The protruding adhesive portion 442 of the second tape 440 and the protruding adhesive layer 434 of the first tape 430 may be adhered to each other. The first tape 430 and the second tape 440 may be fixed to the substrate portion 410 by the protruding adhesive portion 442 and the protruding adhesive layer 434.

FIG. 4C shows a cross-section taken along A-A′ of FIG. 4A. An electrode tab 420 may be joined to the first surface 450 of the substrate portion 410. The first surface 450 of the substrate portion 410 in the illustrated drawing may be an uncoated portion. A part of the electrode tab 420 may be attached to the uncoated portion. The electrode tab 420 may be covered with the first tape 430. The first tape 430 may cover a part of the electrode tab 420 attached to the uncoated portion. The first tape 430 may be in contact with the first surface 450 of the substrate portion 410. The first tape 430 may be positioned along the direction of a battery core. In cases where the electrode assembly is in the form of a jelly roll, when the electrode assembly is rolled, the first tape 430 may be positioned in the direction of the core of the electrode assembly, i.e., towards the interior direction of the electrode assembly.

The second tape 440 may be adhered to the second surface 460 opposite to the first surface 450 of the substrate portion 410. The second tape 440 may have the adhesive layer (not shown) formed over the entire area. The second tape 440 may be configured to fix the first tape 430. The first tape 430 and the second tape 440 may protrude in the external direction from the upper end and the lower end of the substrate portion 410. The first tape 430 and the second tape 440 may be fixed to the substrate portion 410 by bonding to each other at the protruding portions.

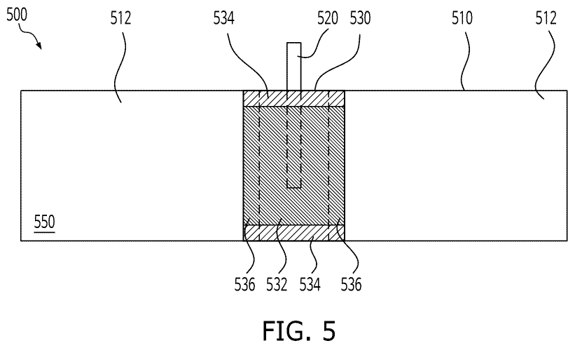

FIG. 5 shows a secondary battery electrode 500, to which a first tape 530 is attached, according to embodiments of the present disclosure.

A first tape 530 is in contact with the first surface 550 on a substrate portion 510. The first tape 530 may cover a part 536 of the uncoated portion (not shown) and the mixture portion 512 on the first surface 550. The first tape 530 may cover a part of the electrode tab 520 joined to the uncoated portion of the first surface 550.

The first tape 530 may include a central portion 532 and an adhesive layer 534. The central portion 532 may include a portion made only of a fabric of the tape or may include a portion where no adhesive is applied. The central portion 532 may include a non-adhesive portion. The central portion 532 may be in contact with the uncoated portion on the first surface 550 of the substrate portion 510. The part 536 of the central portion 532 may overlap with the mixture portion 512. The side end portions 536 (e.g., the left hand side and right hand side end portions of FIG. 5) of the central portion 532 may overlap with the mixture portion 512. The central portion 532 may cover a part of the electrode tab 520 joined to the uncoated portion of the first surface 550.

The adhesive layer 534 may include a portion where an adhesive is applied and may be adhered to the uncoated portion and the mixture portion 512. The adhesive layer 534 may be formed only at two side end portions of the first tape 530. The adhesive layer 534 may be formed in a direction perpendicular to the externally protruding direction of the electrode tab 520. The adhesive layer 534 may be formed at the upper end and the lower end (both the upper end and lower end perpendicular from the two side end portions) of the first tape 530. The adhesive layer 534 may overlap with a part of the mixture portion 512 of the first surface 550 of the substrate portion 510. The adhesive layer 534 may be bonded to the electrode tab 520, the uncoated portion, and the mixture portion 512.

In an embodiment, the second surface (not shown) of the substrate portion 510 may have the same configuration as the second surface shown in FIG. 3B.

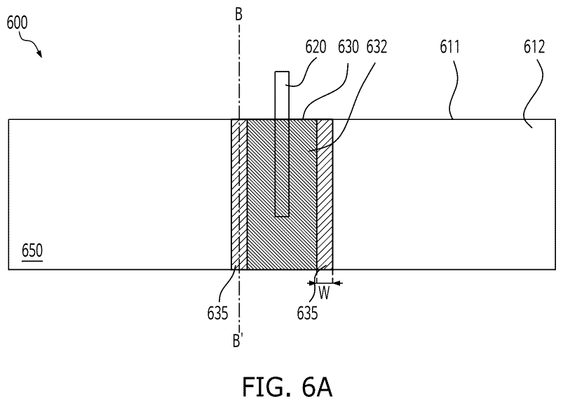

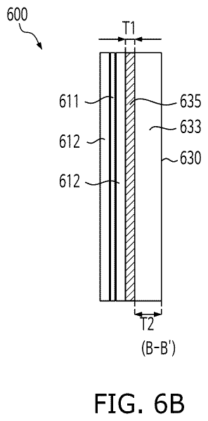

FIGS. 6A-6B show a tape according to embodiments of the present disclosure.

FIG. 6A shows a secondary battery electrode 600 to which a first tape 630 is attached. FIG. 6B shows a cross-sectional view of a secondary battery electrode 600 to which a first tape 630 is attached, taken along line B-B′ of FIG. 6A. The first tape 630 of the secondary battery electrode 600 may be attached to an uncoated portion (not shown) included on a first surface 650 of a substrate portion 611. The uncoated portion may be formed between mixture portions 612. The first tape 630 may include a central portion (not shown) and an adhesive layer 635. The central portion may include a fabric layer 633 of the first tape 630 and may include a portion where no adhesive is applied. The adhesive layer 635 may include a portion where an adhesive is applied and may be adhered to the mixture portion 612. The fabric layer 633 may be a portion of the first tape 630 that is not coated with an adhesive and can be made only of the material of the first tape 630. The adhesive layer 635 may be formed at two side end portions (not shown) of the first tape 630. A width W of the adhesive layer 635 may be expressed as follows.

$$2.5 mm \leq w \leq 5. mm \qquad [ Equation 1 ]$$

The adhesive layer 635 may be positioned on the mixture portion 612 formed in the substrate portion 611. The adhesive layer 635 may be a portion of the fabric layer 633 coated with an adhesive. The adhesive layer 635 may be configured to attach the first tape 630 to the substrate portion 611. A thickness T1 of the adhesive layer 635 may be expressed as follows.

$$5 μm \leq T 1 \leq 15 μm \qquad [ Equation 2 ]$$

The adhesive layer 635 may include an acrylic co-polymer or a rubber sealant. The fabric layer 633 may be positioned on the adhesive layer 635. The fabric layer 633 may be made of the material of the first tape 630. A thickness T2 of the fabric layer 633 may be expressed as follows.

$$10 μm \leq T 2 \leq 50 μm \qquad [ Equation 3 ]$$

The fabric layer 633 may include polypropylene (PP), polyethylene (PE), polyethylene terephthalate (PET), polystyrene (PS), and polyimide (PI), or any combination thereof.

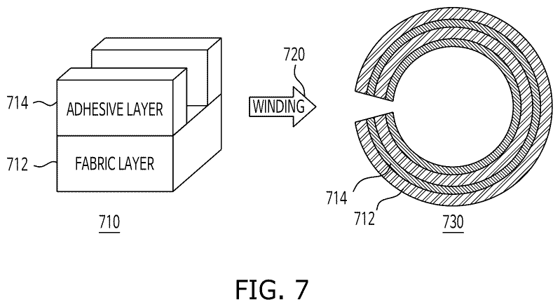

FIG. 7 shows a first tape 710, 720, 730, according to embodiments of the present disclosure.

The unwound first tape 710 may include a fabric layer 712 and an adhesive layer 714. The fabric layer 712 may correspond to the material of the first tape. In an embodiment, the fabric layer 712 may include polypropylene, polyethylene, polyethylene terephthalate, polystyrene, polyimide, or any combination thereof.

An adhesive may be applied onto the fabric layer 712. The adhesive may be applied only to two side end portions of the unwound first tape 710 in a certain pattern, forming the adhesive layer 714. The adhesive layer 714 may include an acrylic copolymer or a rubber sealant.

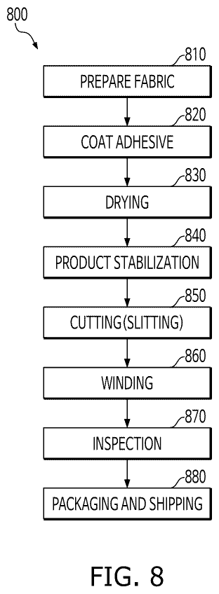

The unwound first tape 710 having the adhesive layer 714 formed thereon may be wound to form a wound first tape 720. The wound first tape 720 may be formed in the form of a jelly roll 730. A detailed process method of the first tape is described with reference to FIG. 8.

FIG. 8 is a flowchart 800 showing a process of forming a first tape according to embodiments of the present disclosure.

A fabric of the first tape may be prepared (810). The material of the fabric of the first tape may include one of PP, PE, PET, PS, and PI, or any combination thereof. An adhesive may be coated on the fabric of the first tape (820). The adhesive may be applied only to two end portions of the first tape in a certain pattern format. The adhesive layer applied in a certain pattern format may be formed. The material of the adhesive layer may include an acrylic copolymer or a rubber sealant. The adhesive layer may include a release paper. The configuration of the release paper is not essential and may be used only when necessary. The release paper may also be provided to prevent the adhesive layers from being bonded to each other.

The adhesive applied on the fabric may be dried at high temperature (830). After high-temperature drying, the product of the first tape may be stabilized (840). Through the above process, the structure of the first tape may be stabilized and the first tape may be in a usable state.

After the product is stabilized, the adhesive layer applied onto the fabric in a certain pattern format may be cut and/or slit (850). The first tape may be cut and/or slit so that an adhesive layer is formed only on two end portions. The cut and/or slit first tape may be wound (860). The first tape may be wound in the form of a jelly roll. After the final inspection 870 of the wound first tape, the product may be packaged and shipped (880).

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

### DESCRIPTION OF SOME REFERENCE SYMBOLS

100: electrode assembly
110: first electrode
120: second electrode
130: separator

What is claimed is:

1. A secondary battery electrode, comprising:
a substrate comprising a first surface and a second surface opposite to the first surface;
a plurality of mixture portions formed on the first surface;
an uncoated portion formed between the plurality of mixture portions on the first surface;
an electrode tab joined to the uncoated portion and externally protruding from the uncoated portion; and
a tape in contact with the first surface and comprising two side end portions and a central portion formed between the two side end portions,
wherein an adhesive layer is formed on the two side end portions, and
wherein the tape covers a part of the electrode tab and at least a part of the uncoated portion.

2. The secondary battery electrode as claimed in claim 1, wherein the adhesive layer exists parallel to an externally protruding direction of the electrode tab and wherein the adhesive layer is adhered to the plurality of mixture portions.

3. The secondary battery electrode as claimed in claim 2, further comprising:
a second plurality of mixture portions formed on the second surface;
a second uncoated portion formed between the second plurality of mixture portions on the second surface;
a second tape in contact with the second surface at a position corresponding to the tape,
wherein a second adhesive layer is formed on an entire area of the second tape, and
wherein the second tape covers at least a part of the second uncoated portion and at least a part of the second plurality of mixture portions.

4. The secondary battery electrode as claimed in claim 1, wherein the adhesive layer exists perpendicular to an externally protruding direction of the electrode tab, wherein the adhesive layer is positioned at an upper end and a lower end of the tape, and wherein the adhesive layer does not overlap with the plurality of mixture portions.

5. The secondary battery electrode as claimed in claim 4, further comprising:
a second plurality of mixture portions formed on the second surface;
a second uncoated portion formed between the second plurality of mixture portions on the second surface;
a second tape in contact with the second surface at a position corresponding to the first tape,
wherein a second adhesive layer is formed on an entire area of the second tape, and
wherein the second tape covers at least a part of the second uncoated portion, at least a part of the second plurality of mixture portions, and a part of the electrode tab.

6. The secondary battery electrode as claimed in claim 1, wherein the adhesive layer exists perpendicular to an externally protruding direction of the electrode tab, wherein the adhesive layer is positioned at an upper end and a lower end of the tape, and wherein at least a part of the adhesive layer overlaps with at least a part of the plurality of mixture portions.

7. The secondary battery electrode as claimed in claim 6, further comprising:
a second plurality of mixture portions formed on the second surface;
a second uncoated portion formed between the second plurality of mixture portions on the second surface;
a second tape in contact with the second surface at a position corresponding to the first tape,
wherein a second adhesive layer is formed on an entire area of the second tape, and
wherein the second tape covers at least a part of the second uncoated portion and at least a part of the second plurality of mixture portions.

8. The secondary battery electrode as claimed in claim 1, wherein the adhesive layer has a width of about 2.5 mm to about 5.0 mm.

9. The secondary battery electrode as claimed in claim 1, wherein the adhesive layer has a thickness of about 5 μm to about 15 μm.

10. The secondary battery electrode as claimed in claim 1, wherein the adhesive layer comprises an acrylic co-polymer or a rubber sealant.

11. The secondary battery electrode as claimed in claim 1, wherein the the tape comprises polypropylene, polyethylene, polyethylene terephthalate, polystyrene, polyimide, or any combination thereof.

12. The secondary battery electrode as claimed in claim 1, wherein the tape has a thickness of about 10 μm to about 50 μm.

13. An electrode assembly comprising:
a first electrode;
a second electrode; and
a separator positioned between the first electrode and the second electrode,
wherein the first electrode and/or the second electrode comprises:
a substrate comprising a first surface and a second surface opposite to the first surface;
a plurality of mixture portions formed on the first surface;
an uncoated portion formed between the plurality of mixture portions on the first surface;
an electrode tab joined to the uncoated portion and externally protruding from the uncoated portion; and
a tape in contact with the first surface and comprising two side end portions and a central portion formed between the two side end portions,
wherein an adhesive layer is formed on the two side end portions, and
wherein the tape covers a part of the electrode tab and at least a part of the uncoated portion.

14. The electrode assembly as claimed in claim 13, wherein the adhesive layer exists parallel to an externally protruding direction of the electrode tab and wherein the adhesive layer is adhered to the plurality of mixture portions.

15. The electrode assembly as claimed in claim 14, wherein the first electrode and/or the second electrode further comprises:
a second plurality of mixture portions formed on the second surface;
a second uncoated portion formed between the second plurality of mixture portions on the second surface;
a second tape in contact with the second surface at a position corresponding to the tape,
wherein a second adhesive layer is formed on an entire area of the second tape, and
wherein the second tape covers at least a part of the second uncoated portion and at least a part of the second plurality of mixture portions.

16. The electrode assembly as claimed in claim 13, wherein the adhesive layer exists perpendicular to an externally protruding direction of the electrode tab, wherein the adhesive layer is positioned at an upper end and a lower end of the tape, and wherein the adhesive layer does not overlap with the plurality of mixture portions.

17. The electrode assembly as claimed in claim 16, wherein the first electrode and/or the second electrode further comprises:
a second plurality of mixture portions formed on the second surface;
a second uncoated portion formed between the second plurality of mixture portions on the second surface;
a second tape in contact with the second surface at a position corresponding to the first tape,
wherein a second adhesive layer is formed on an entire area of the second tape, and
wherein the second tape covers at least a part of the second uncoated portion and at least a part of the second plurality of mixture portions, and a part of the electrode tab.

18. The electrode assembly as claimed in claim 13, wherein the adhesive layer exists perpendicular to an externally protruding direction of the electrode tab, wherein the adhesive layer is positioned at an upper end and a lower end of the tape, and wherein at least a part of the adhesive layer overlaps with at least a part of the plurality of mixture portions.

19. The electrode assembly as claimed in claim 18, wherein the first electrode and/or the second electrode further comprises:
a second plurality of mixture portions formed on the second surface;
a second uncoated portion formed between the second plurality of mixture portions on the second surface;
a second tape in contact with the second surface at a position corresponding to the first tape,
wherein a second adhesive layer is formed on an entire area of the second tape, and
wherein the second tape covers at least a part of the second uncoated portion and at least a part of the second plurality of mixture portions.

20. A method for producing the electrode assembly as claimed in claim 13, comprising:
winding the first electrode, the separator, and the second electrode to form a jelly roll type electrode assembly, or
stacking the first electrode, the separator, and the second electrode to form a stacked type electrode assembly.
